(19) United States
(12) Patent Application Publication
(10) Pub. No.: US 2025/0136502 A1
(43) Pub. Date: May 1, 2025

(54) COLORED COATED OPTICAL FIBER AND METHOD OF MANUFACTURING THE SAME

(71) Applicant: FURUKAWA ELECTRIC CO., LTD., Tokyo (JP)

(72) Inventors: Kuniaki ISHIZUKI, Tokyo (JP); Mitsuhiro IWAYA, Tokyo (JP)

(73) Assignee: FURUKAWA ELECTRIC CO., LTD., Tokyo (JP)

(21) Appl. No.: 19/009,451

(22) Filed: Jan. 3, 2025

Related U.S. Application Data
(63) Continuation of application No. PCT/JP2023/028382, filed on Aug. 3, 2023.

(30) Foreign Application Priority Data
Aug. 5, 2022 (JP) 2022-125352

(51) Int. Cl. C03C 25/1065; C03C 25/105

(52) U.S. Cl. CPC C03C 25/1065; C03C 25/105; C03C 2218/32

(57) ABSTRACT

A colored coated optical fiber includes: a bare optical fiber; a primary layer formed of a first ultraviolet curable resin covering the bare optical fiber; and a secondary layer formed of a second ultraviolet curable resin covering the primary layer, wherein the primary layer has a carbon-sulfur bond and contains 0.03 wt % or more and 0.65 wt % or less of sulfur atoms, and wherein an increase in a Young's modulus of the primary layer due to additional ultraviolet irradiation to the primary layer is 0.09 MPa or less.

### CROSS-REFERENCE TO RELATED APPLICATIONS

This application is a Continuation of International Patent Application No. PCT/JP2023/028382, filed Aug. 3, 2023, which claims the benefit of Japanese Patent Application No. 2022-125352, filed Aug. 5, 2022, both of which are hereby incorporated by reference herein in their entirety.

### BACKGROUND OF THE INVENTION

### Field of the Invention

The present invention relates to a colored coated optical fiber and a method of manufacturing the same.

### Background Art

A technique is known in which a primary layer covering a bare optical fiber, a secondary layer covering the primary layer, and a colored layer covering the secondary layer are formed to have a desired Young's modulus by using ultraviolet curable resins to manufacture a colored coated optical fiber (Patent Literature 1). When the Young's modulus of the primary layer is set low, it is possible to reduce an external force applied to the bare optical fiber, and suppress transmission loss of light due to minute deformation of the bare optical fiber (Hereinafter referred to as “micro-bending loss”).

In order to lower the Young's modulus of the primary layer, it is necessary to lower the saturated Young's modulus, which is the maximum Young's modulus in which the ultraviolet curable resin constituting the primary layer can exhibit. However, in order to lower the saturated Young's modulus, it is generally necessary to change the composition of monomers and oligomers that constitute the majority of the ultraviolet curable resins, and it is necessary to significantly change the resin composition.

In order to reduce the Young's modulus without a significant change in the resin composition, it is considered to reduce the illuminance and irradiation amount of ultraviolet light irradiated in optical fiber manufacturing. In this case, however, even if the Young's modulus of the primary layer is low in the optical fiber just after manufacturing, the Young's modulus of the primary layer may increase when ultraviolet light is irradiated in the manufacturing process of the optical fiber ribbon. In contrast, a method of manufacturing a colored coated optical fiber or an optical fiber ribbon in which the primary layer has a Young's modulus close to the saturated Young's modulus has been proposed (Patent Literatures 2 and 3).

On the other hand, in general, several additives are added to ultraviolet curable resins used for optical fiber coatings. As the additives, there are silane coupling agents which improve the adhesion force between the glass and the primary layer. It is known that when a silane coupling agent containing a mercapto group is used, the mercapto group acts as a polymerization inhibitor and the curability of the coated resin is reduced (Patent Literature 4).

### CITATION LIST

### Patent Literature

Patent Literature 1: Japanese Patent Application Laid-Open No. 2005-162522

Patent Literature 2: Japanese Patent No. 6841836

Patent Literature 3: Japanese Patent No. 6841837

Patent Literature 4: Japanese Patent Application Laid-Open No. 2013-88508

### SUMMARY OF THE INVENTION

### Technical Problem

In order to improve the optical transmission capability of the optical fiber by reducing the micro-bending loss, it is necessary to set the Young's modulus of the primary layer covering the bare optical fiber to be low as described above. However, when the resin is not cured sufficiently and the reactive group which can participate in the curing remains in the resin, there is a risk that the Young's modulus may increase unexpectedly due to ultraviolet irradiation in the coloring process, the taping process, or the like after the optical fiber is manufactured, or the primary layer is exposed to light containing ultraviolet light.

On the other hand, in the case of the colored coated optical fiber in which the primary layer has a Young's modulus close to the saturated Young's modulus as described in Patent Literatures 2 and 3, the saturated Young's modulus of the resin is determined from monomers, oligomers, and the like constituting the majority of the resin, and therefore, it is necessary to significantly change the resin composition in order to realize the low Young's modulus. In addition, in the mercapto group-containing silane coupling agent described in Patent Literature 4 as the additive for improving the adhesion force between the glass and the primary layer, the low Young's modulus of the primary layer cannot be sufficiently achieved even with the decrease of the curability.

It is an object of the present invention to provide a colored coated optical fiber and a method of manufacturing the same capable of reducing the Young's modulus of the primary layer to a desired Young's modulus and suppressing or preventing an increase in the Young's modulus without a large change in the resin composition.

### Solution to Problem

According to one aspect of the present invention, there is provided a colored coated optical fiber including: a bare optical fiber; a primary layer formed of a first ultraviolet curable resin covering the bare optical fiber; and a secondary layer formed of a second ultraviolet curable resin covering the primary layer, wherein the primary layer has a carbon-sulfur bond and contains 0.03 wt % or more and 0.65 wt % or less of sulfur atoms, and wherein an increase in a Young's modulus of the primary layer due to additional ultraviolet irradiation to the primary layer is 0.09 MPa or less.

According to another aspect of the present invention, there is provided a method of manufacturing a colored coated optical fiber, the method including the steps of: drawing a bare optical fiber from an optical fiber preform; applying a first ultraviolet curable resin around the bare optical fiber to form a primary layer; and applying a second ultraviolet curable resin around the primary layer to form a secondary layer, wherein the primary layer has a carbon-sulfur bond and contains 0.03 wt % or more and 0.65 wt % or less of sulfur atoms, and wherein an increase in a Young's modulus of the primary layer due to additional ultraviolet irradiation to the primary layer is 0.09 MPa or less.

### Advantageous Effects of Invention

According to the present invention, it is possible to reduce the Young's modulus of the primary layer to a desired Young's modulus without a significant change in the resin composition, and the increase in the Young's modulus can be suppressed or prevented.

### BRIEF DESCRIPTION OF THE DRAWINGS

FIG. 1A is a cross-sectional view of a colored coated optical fiber according to one embodiment.

FIG. 1B is a cross-sectional view of a coated optical fiber according to the embodiment.

FIG. 2A is a schematic diagram of a part of a manufacturing apparatus used in a method of manufacturing the colored coated optical fiber according to the embodiment.

FIG. 2B is a schematic diagram illustrating another part of the manufacturing apparatus used in the method of manufacturing the colored coated optical fiber according to the embodiment.

FIG. 3A is a cross-sectional view of an example of an optical fiber ribbon according to the embodiment.

FIG. 3B is a cross-sectional view of another example of the optical fiber ribbon according to the embodiment.

FIG. 3C is a cross-sectional view of another example of the optical fiber ribbon according to the embodiment.

FIG. 4 is a schematic diagram of a ribbon forming apparatus used in a method of manufacturing the optical fiber ribbon according to the embodiment.

FIG. 5 is a flowchart of the method of manufacturing the colored coated optical fiber and the optical fiber ribbon according to the embodiment.

FIG. 6 is a graphical diagram showing the relationship between the Young's modulus difference of the primary layer of the colored coated optical fiber and the rate at which the micro-bending loss difference is 0.05 dB/km or more for the primary layers of a plurality of colored coated optical fibers.

### DESCRIPTION OF THE EMBODIMENTS

One embodiment of the present invention will be described below in detail with reference to the drawings. Elements that have common functions may be given the same reference numerals throughout the drawings, and overlapping descriptions may be omitted or simplified.

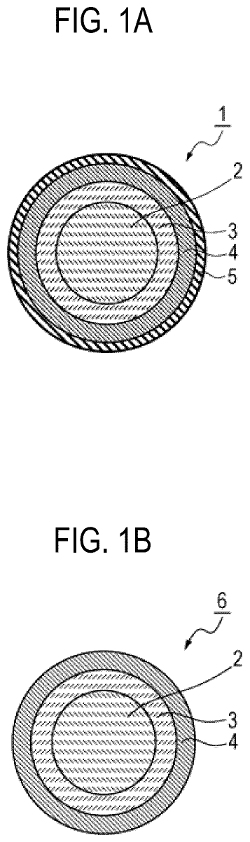

FIG. 1A is a cross-sectional view of the colored coated optical fiber 1 according to the present embodiment. The colored coated optical fiber 1 includes a bare optical fiber 2, a primary layer 3 coated on the outer periphery of the bare optical fiber 2, a secondary layer 4 coated on the outer periphery of the primary layer 3, and a colored layer 5 coated on the outer periphery of the secondary layer 4. The bare optical fiber 2 is coated with three coating layers of the primary layer 3, the secondary layer 4, and the colored layer 5. FIG. 1B is a cross-sectional view of the coated optical fiber 6 according to the present embodiment. The coated optical fiber 6 is a fiber in a state before the colored layer 5 is formed.

The bare optical fiber 2 is formed of, for example, quartz glass or the like and transmits light. Each of the primary layer 3, the secondary layer 4 and the colored layer 5 is formed by curing an ultraviolet curable resin by irradiation of ultraviolet light. The ultraviolet curable resin is not particularly limited as long as the ultraviolet curable resin can be polymerized by irradiation with ultraviolet light. The ultraviolet curable resin can be polymerized by, for example, photo-radical polymerization or the like.

The ultraviolet curable resin is, for example, an ultraviolet curable resin having a polymerizable unsaturated group such as an ethylenically unsaturated group or the like, which polymerizes and cures under ultraviolet light, such as urethane (meth)acrylate such as polyether-based urethane (meth)acrylate and polyester-based urethane (meth)acrylate, epoxy (meth)acrylate, polyester (meth)acrylate, or the like, and is preferably having at least two polymerizable unsaturated groups.

The polymerizable unsaturated group in the ultraviolet curable resin includes, for example, a group having an unsaturated double bond such as a vinyl group, an allyl group, an acryloyl group, a methacryloyl group, and a group having an unsaturated triple bond such as a propargyl group. Among them, an acryloyl group and a methacryloyl group are preferable in terms of polymerizability.

Further, the ultraviolet curable resin may be a monomer, an oligomer or a polymer, which initiates polymerization and cures upon irradiation with ultraviolet light, and is preferably an oligomer. Note that the oligomer is a polymer having a degree of polymerization of 2 to 100. Note also that, in the present specification, “(meth)acrylate” means one or both of acrylate and methacrylate. The ultraviolet curable resin includes any photopolymerization initiator (hereinafter referred to as “photoinitiator”) having sensitivity in the ultraviolet region.

The polyether-based urethane (meth)acrylate is a compound having a polyether segment, a (meth)acrylate and a urethane bond, such as a reaction product of a polyol having a polyether skeleton with an organic polyisocyanate compound and a hydroxyalkyl (meth)acrylate. The polyester-based urethane (meth)acrylate is a compound having a polyester segment, a (meth)acrylate and a urethane bond, such as a reaction product of a polyol having a polyester skeleton with an organic polyisocyanate compound and a hydroxyalkyl (meth)acrylate.

Further, the ultraviolet curable resin may include, for example, a dilution monomer, a photosensitizer, an ultraviolet absorber, an antioxidant, a silane coupling agent, a chain transfer agent and various additives in addition to the oligomer and the photoinitiator. Monofunctional (meth)acrylate or multifunctional (meth)acrylate is used as the dilution monomer. Here, the dilution monomer means a monomer for diluting an ultraviolet curable resin.

The primary layer 3 is a soft layer and has a function for buffering an external force applied to the bare optical fiber 2. Although there is a possibility that the primary layer 3 when the coated optical fiber 6 is formed still has room to cure, the Young's modulus of the primary layer 3 is maximized when the primary layer 3 is cured until there is no room to cure. In the present embodiment, the maximum Young's modulus that the primary layer 3 of the coated optical fiber 6 can exhibit is defined as “saturated Young's modulus”.

The ultraviolet curable resin constituting the primary layer 3 may contain a mercapto group-containing compound because the primary layer 3 is constituted so as to have a carbon-sulfur bond as described later. The mercapto group-containing compound is a compound having at least one mercapto group in one molecule. The mercapto group-containing compound reacts with a polymerizable compound such as urethane (meth)acrylate contained in the ultraviolet curable resin with a mercapto group to stop the polymerization of the polymerizable compound. The mercapto group-containing compound includes, but is not limited to, for example, (3-mercaptopropyl)trimethoxysilane, isooctyl 3-mercaptopropionate, 1-pentanethiol, which were used in examples described later, and also includes ethyl mercaptan, 1-butanethiol, 1-heptanethiol, 1-undecanethiol, 4-hydroxybenzenethiol, (2-mercaptoethyl)pyrazine, 2,3-butanedithiol, 3-methyl-2-butanethiol, 3-mercapto-1,2,4-triazole, 1,3,4-thiadiazole-2-thiol, isobutyl mercaptan, 4-methoxy-α-toluenethiol, 4,4′-biphenyldithiol, trimethylsilylmethanethiol, 1,4-butanedithiol, 1,8-octanedithiol, (3-mercaptopropyl)triethoxysilane, 3-ethoxybenzenethiol, and pentaerythritol tetra(3-mercaptopropionate).

The irradiation of ultraviolet light is carried out at appropriate illuminance and irradiation amount at any time using, for example, a mercury lamp, UV-LED, or the like. The saturated Young's modulus varies depending on the optical fiber manufacturing conditions (linear speed, UV irradiation intensity, UV light source type, resin coating temperature, and the like, for example), and cannot be determined unambiguously depending on the ultraviolet curable resin used.

The secondary layer 4 is preferably a hard layer having a Young's modulus of 500 MPa or more, and has a function for protecting the bare optical fiber 2 and the primary layer 3 from an external force.

The colored layer 5 is the outermost layer of the colored coated optical fiber 1, and has a function for protecting the bare optical fiber 2, the primary layer 3 and the secondary layer 4 from an external force. The colored layer 5 is colored by a coloring agent in which a pigment, a lubricant, and the like are mixed to distinguish the colored coated optical fiber 1. The colors include, for example, white, black, gray, purple, blue, light blue, green, brown, yellow, orange, pink, red, and the like.

The diameter of the bare optical fiber 2 may be, for example, 80 μm or more and 150 μm or less, and preferably 124 μm or more and 126 μm or less. The thickness of the primary layer 3 may be preferably 5 μm or more and 60 μm or less. The thickness of the secondary layer 4 may be preferably 5 μm or more and 60 μm or less. The thickness of the colored layer 5 may be preferably several μm. Here, the diameter of the coated optical fiber 6 can be determined by the sum of the diameter of the bare optical fiber 2, the length of twice the thickness of the primary layer 3, and the length of twice the thickness of the secondary layer 4. Therefore, the diameter of the bare optical fiber 2, the thickness of the primary layer 3, and the thickness of the secondary layer 4 may be selected so that the diameter of the coated optical fiber 6 is, for example, about 190 μm to 250 μm.

Note that, in the present embodiment, a case where the colored layer 5 is formed separately from the secondary layer 4 will be described, but the colored layer 5 is not formed and the secondary layer 4 may be colored to function as the colored layer. In this case, the secondary layer 4 may be colored by including a coloring agent similar to the coloring agent for coloring the colored layer 5 in the ultraviolet curable resin constituting the secondary layer 4.

An effective core cross-sectional area (valid core cross-sectional area) Aeff can be used as an index for indicating the likelihood of micro-bending loss in an optical fiber. The effective core cross-sectional area Aeff is expressed by the following expression (1). Note that the effective core cross-sectional area Aeff is described, for example, in C-3-76 and C-3-77 of the Proceedings of the 1999 Electronics Society Conference of the Institute of Electronics, Information and Communication Engineers., and the like.

$$Aeff = ( π k / 4 ) * {( MED )}^{2} \qquad ( 1 )$$

Here, the effective core cross-sectional area Aeff is a value at a wavelength of 1550 nm, MED is a mode field diameter (μm), and k is a constant. The effective core cross-sectional area Aeff represents an area of a portion of a cross section orthogonal to the axis of the bare optical fiber 2 through which light having a predetermined intensity passes. In general, the larger the effective core cross-sectional area Aeff of the bare optical fiber 2 becomes, the weaker the optical confinement in the cross section of the bare optical fiber 2 becomes. That is, when the effective core cross-sectional area Aeff of the bare optical fiber 2 is large, light in the bare optical fiber 2 tends to leak due to an external force applied to the bare optical fiber 2. Therefore, when the effective core cross-sectional area Aeff of the bare optical fiber 2 is large, the micro-bending loss of the colored coated optical fiber 1 tends to occur.

As the bare optical fiber 2, the effective core cross-sectional area Aeff of 80 μm² or more (≥80 μm²) may be used. In an optical fiber, Aeff is an index of the micro-bending sensitivity, and a larger Aeff indicates a higher micro-bending sensitivity (In general, it is said that the micro-bending sensitivity is high if Aeff>100 μm²). In particular, when the Aeff is 130 μm² or more and 150 μm 2 or less, the micro-bending sensitivity is high without any question.

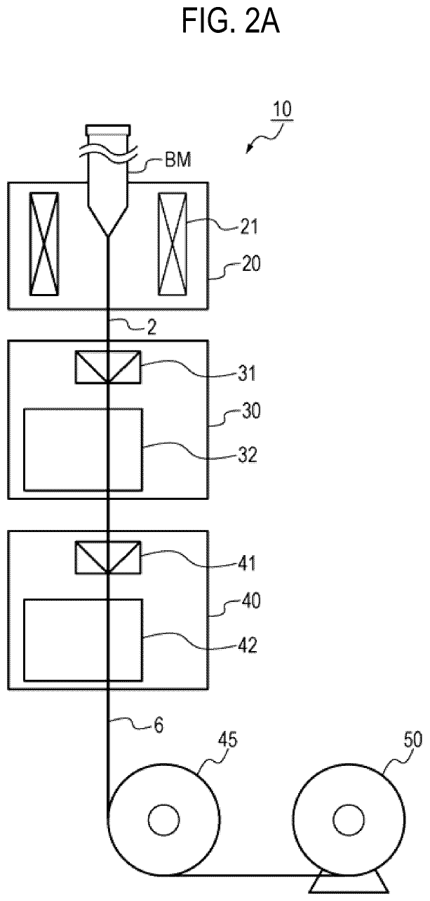

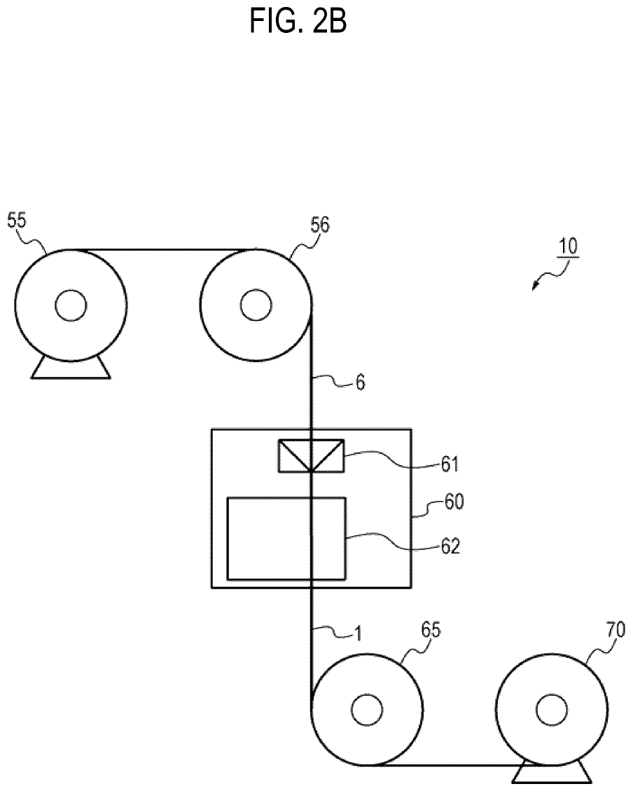

FIG. 2A is a schematic diagram showing a part of a manufacturing apparatus 10 used in a method of manufacturing the colored coated optical fiber 1 according to the present embodiment. In FIG. 2A, the manufacturing apparatus 10 includes a heating apparatus 20, a primary layer coating apparatus 30, a secondary layer coating apparatus 40, a guide roller 45, and a first winding apparatus 50.

The optical fiber preform BM is made of quartz glass, for example, and is manufactured by well-known methods such as VAD method, OVD method, MCVD method, or the like. The heating apparatus 20 has a heater 21. The heater 21 may be any arbitrary heat source such as a tape heater, a ribbon heater, a rubber heater, an oven heater, a ceramic heater, a halogen heater, or the like. The end of the optical fiber preform BM is heated and melted by the heater 21 arranged around the optical fiber preform BM, and is drawn to make the bare optical fiber 2 drawn out.

The primary layer coating apparatus 30 is provided below the heating apparatus 20. The primary layer coating apparatus 30 includes a resin coating device 31 and an ultraviolet irradiation device 32. The resin coating device 31 holds an ultraviolet curable resin (hereinafter referred to as “first ultraviolet curable resin”), which is a coating material for forming the primary layer 3. The first ultraviolet curable resin is applied to the bare optical fiber 2 drawn from the optical fiber preform BM by the resin coating device 31.

The ultraviolet irradiation device 32 is provided below the resin coating device 31. The ultraviolet irradiation device 32 includes any ultraviolet light source such as a metal halide lamp, a mercury lamp, a UV-LED, or the like. The first ultraviolet curable resin is applied to the bare optical fiber 2 by the resin coating device 31, and the bare optical fiber 2 enters the ultraviolet irradiation device 32 to irradiate the first ultraviolet curable resin with the ultraviolet light. As a result, the first ultraviolet curable resin is cured and the primary layer 3 is formed.

The secondary layer coating apparatus 40 is provided below the primary layer coating apparatus 30. The secondary layer coating apparatus 40 includes a resin coating device 41 and an ultraviolet irradiation device 42. The resin coating device 41 holds an ultraviolet curable resin (hereinafter referred to as “second ultraviolet curable resin”), which is a coating material for forming the secondary layer 4. The second ultraviolet curable resin is applied to the primary layer 3 by the resin coating device 41.

The ultraviolet irradiation device 42 is provided below the resin coating device 41. The ultraviolet irradiation device 42 can be configured similarly to the ultraviolet irradiation device 32. The bare optical fiber 2 coated with the second ultraviolet curing resin on the primary layer 3 enters the ultraviolet irradiation device 42 to irradiate the second ultraviolet curing resin with the ultraviolet light. As a result, the second ultraviolet curing resin is cured, and the secondary layer 4 is formed. The primary layer 3 and the secondary layer 4 are covered on the bare optical fiber 2, thereby forming the coated optical fiber 6.

Note that the resin coating device 31 may be configured to separately hold the first ultraviolet curable resin and the second ultraviolet curable resin. In this case, the resin coating device 31 applies the first ultraviolet curable resin to the bare optical fiber 2, and then applies the second ultraviolet curable resin to the first ultraviolet curable resin. Further, in this case, the ultraviolet irradiation device 32 irradiates the first ultraviolet curable resin and the second ultraviolet curable resin applied to the bare optical fiber 2 with the ultraviolet light. Thus, the primary layer 3 and the secondary layer 4 are formed. In this case, it is not necessary for the manufacturing apparatus 10 to include the secondary layer coating apparatus 40.

A guide roller 45 and a first winding apparatus 50 are provided below the secondary layer coating apparatus 40. The coated optical fiber 6, which has been manufactured, is guided by the guide roller 45 to be wound by the first winding apparatus 50.

FIG. 2B is a schematic diagram illustrating another part of the manufacturing apparatus 10 used in the manufacturing method of the colored coated optical fiber 1 according to the present embodiment. In FIG. 2B, the manufacturing apparatus 10 includes a coated optical fiber holding apparatus 55, a guide roller 56, a colored layer coating apparatus 60, a guide roller 65, and a second winding apparatus 70. The manufacturing apparatus 10 manufactures a colored coated optical fiber 1 from the coated optical fiber 6, which has been manufactured by the plurality of apparatuses or devices illustrated in FIG. 2A.

The coated optical fiber holding apparatus 55 holds the manufactured coated optical fiber 6 in a wound state. Note that, in FIG. 2B, the coated optical fiber holding apparatus 55 is an apparatus that is different from the first winding apparatus 50, but the first winding apparatus 50 may also serve as the coated optical fiber holding apparatus 55.

The colored layer coating apparatus 60 is provided below the coated optical fiber holding apparatus 55. The coated optical fiber 6 drawn out from the coated optical fiber holding apparatus 55 is guided by the guide roller 56 provided between the coated optical fiber holding apparatus 55 and the colored layer coating apparatus 60, and is transported into the colored layer coating apparatus 60.

The colored layer coating apparatus 60 has a resin coating device 61 and an ultraviolet irradiation device 62. The resin coating device 61 holds an ultraviolet curable resin (hereinafter referred to as “third ultraviolet curable resin”), which is a coating material for forming the colored layer 5.

The third ultraviolet curable resin is applied to the coated optical fiber 6 by the resin coating device 61. The ultraviolet irradiation device 62 is provided below the resin coating device 61. The ultraviolet irradiation device 62 can be configured similarly to the ultraviolet irradiation devices 32 and 42.

The coated optical fiber 6 coated with the third ultraviolet curable resin on the outer periphery of the secondary layer 4 enters the ultraviolet irradiation device 62, to irradiate the third ultraviolet curable resin and the coated optical fiber 6 with the ultraviolet light. As a result, the third ultraviolet curable resin is cured, and the colored layer 5 is formed.

The primary layer 3, the secondary layer 4, and the colored layer 5 are coated onto the bare optical fiber 2 to form the colored coated optical fiber 1. The colored coated optical fiber 1, which has been manufactured, is guided by the guide roller 65 provided below the colored layer coating apparatus 60 to be wound by the second winding apparatus 70.

Note that, when the secondary layer 4 is colored without forming the colored layer 5 to make the secondary layer 4 also function as the colored layer, the above-described process by the other part illustrated in FIG. 2B of the manufacturing apparatus 10 may be omitted. In this case, a coloring agent is added to the second ultraviolet curable resin to be coated by the resin coating device 41 and the colored second ultraviolet curable resin can be coated around the primary layer 3. Thus, the secondary layer 4 colored by the coloring agent may be formed.

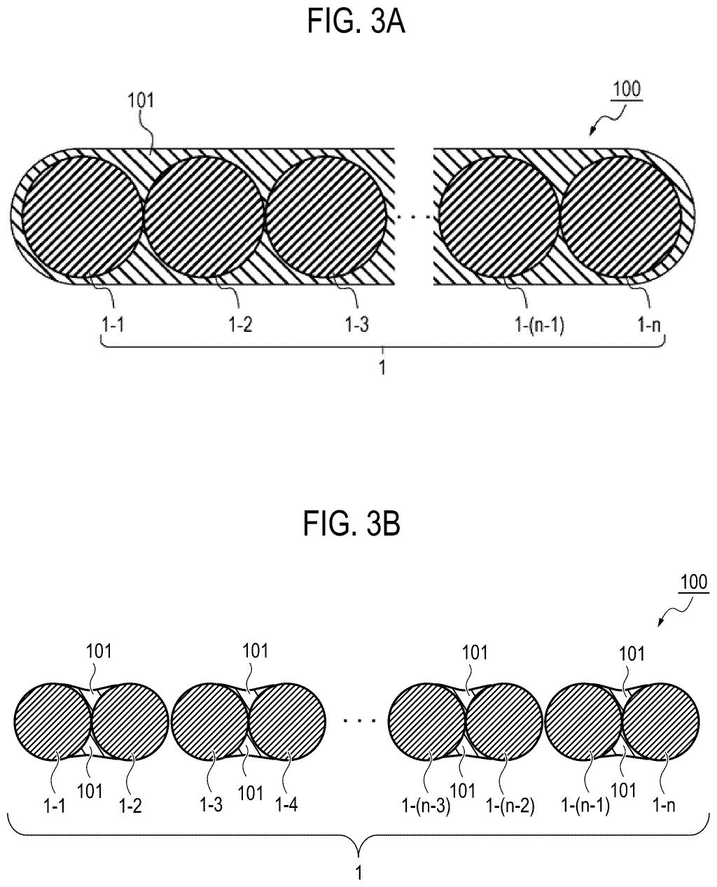

FIG. 3A is a cross-sectional view of an example of an optical fiber ribbon 100 according to the present embodiment. The optical fiber ribbon 100 is constituted by bundling n (n is a natural number greater than or equal to 2) colored coated optical fibers 1-1 to 1-n into a band by an adhesive layer 101. Note that the optical fiber ribbon 100 is not limited to one having a structure in which all of the colored coated optical fibers 1-1 to 1-n are bundled into one as illustrated in FIG. 3A, but may have an intermittent adhesive-type structure as illustrated in FIG. 3B and FIG. 3C. In the optical fiber ribbon 100 having an intermittent adhesive-type structure, two or more colored coated optical fibers 1 continuously arranged in the width direction are bundled into one band by the adhesive layer 101. FIG. 3B and FIG. 3C illustrate structures in each of which two colored coated optical fibers 1 arranged adjacent to each other in the width direction are bundled into one band by the adhesive layer 101. In these cases, as illustrated in FIG. 3B, each of the colored coated optical fibers 1 may be bundled with another colored coated optical fiber 1, and as illustrated in FIG. 3C, a part of the plurality of colored coated optical fibers 1 may not be bundled with the other colored coated optical fibers 1.

Further, in the present embodiment, the same optical fiber ribbon 100 includes two or more types of colored coated optical fibers 1 having the different colored layers 5.

Further, it is preferable that there is no difference in absorbance to ultraviolet light depending on the colors of the colored layers 5. For example, when the colored coated optical fiber 1-1 has the colored layer 5 that is white and the colored coated optical fibers 1-n has the colored layer 5 that is black, the absorbance to ultraviolet light may differ between these two colored coated optical fibers 1. One solution in this case is to add an additive for adjusting the absorbance to ultraviolet light at a predetermined wavelength to the third ultraviolet curable resin for forming the colored layer 5 according to the color of the colored layer 5 to be formed. By appropriately adjusting the type of the additive and the amount of the additive for each color of the colored layer 5, the difference in absorbance between the plurality of colored coated optical fibers 1-1 to 1-n can be reduced.

Note that it is preferable that at least a part of the wavelength range (first wavelength range) in which the additive added to the third ultraviolet curable resin absorbs ultraviolet light overlaps the wavelength range (second wavelength range) in which the light initiator added to the first ultraviolet curable resin absorbs ultraviolet light.

The adhesive layer 101 is formed by curing a coating material containing the ultraviolet curable resin by irradiating ultraviolet light. The adhesive layer 101 is also referred to as a ribbon layer in the present specification. The ultraviolet curable resin for forming the adhesive layer 101 is composed of the same resin as the ultraviolet curable resins for forming the primary layer 3, the secondary layer 4 and the colored layer 5. The colored coated optical fibers 1 may be bundled in high density by taking the form of the optical fiber ribbon 100. Note that the optical fiber ribbon 100 is not limited to the configuration illustrated in FIG. 3A, FIG. 3B, and FIG. 3C. The optical fiber ribbon cable in which the optical fiber ribbon 100 is accommodated by a sheath may be formed.

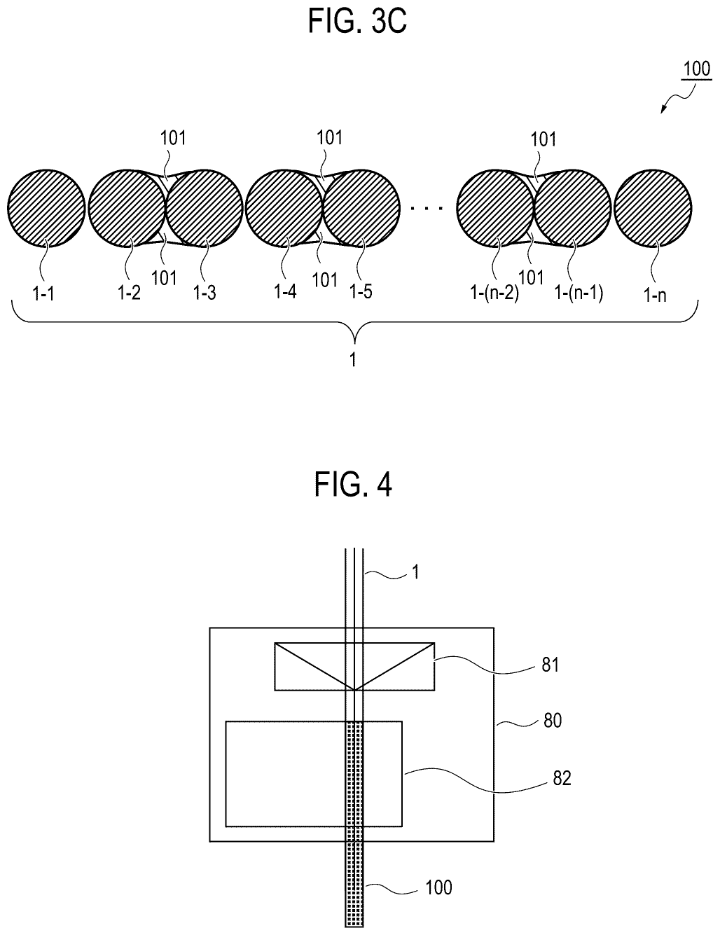

FIG. 4 is a schematic diagram of a ribbon forming apparatus 80 used in a manufacturing method of the optical fiber ribbon 100 according to the present embodiment. The ribbon forming apparatus 80 includes a resin coating device 81 and an ultraviolet irradiation device 82. The resin coating device 81 holds an ultraviolet curable resin (hereinafter referred to as “fourth ultraviolet curable resin”), which is a coating material of the adhesive layer 101.

A plurality of colored coated optical fibers 1 prepared in different colors enter the ribbon forming apparatus 80, and are applied with the fourth ultraviolet curable resin by the resin coating device 81. The colored coated optical fiber 1 coated with the fourth ultraviolet curable resin are bundled together with other plurality of colored coated optical fibers 1 coated with the fourth ultraviolet curable resin. The bundled plurality of colored coated optical fibers 1 are irradiated with ultraviolet light by the ultraviolet irradiation device 82 provided in the ribbon forming apparatus 80. As a result, the fourth ultraviolet curable resin is cured to form the adhesive layer 101. The plurality of colored coated optical fibers 1 arranged in parallel by the adhesive layer 101 are connected. Thus, the optical fiber ribbon 100 is formed from the plurality of colored coated optical fibers 1.

Note that the ribbon forming apparatus 80 may be, for example, a ribbon forming apparatus described in Japanese Patent Application Laid-Open No. 2012-118358. Thus, the adhesive layer 101 is intermittently formed with a predetermined interval in the longitudinal direction of the adjacent colored coated optical fiber 1, and the intermittent adhesive type optical fiber ribbon 100 is formed.

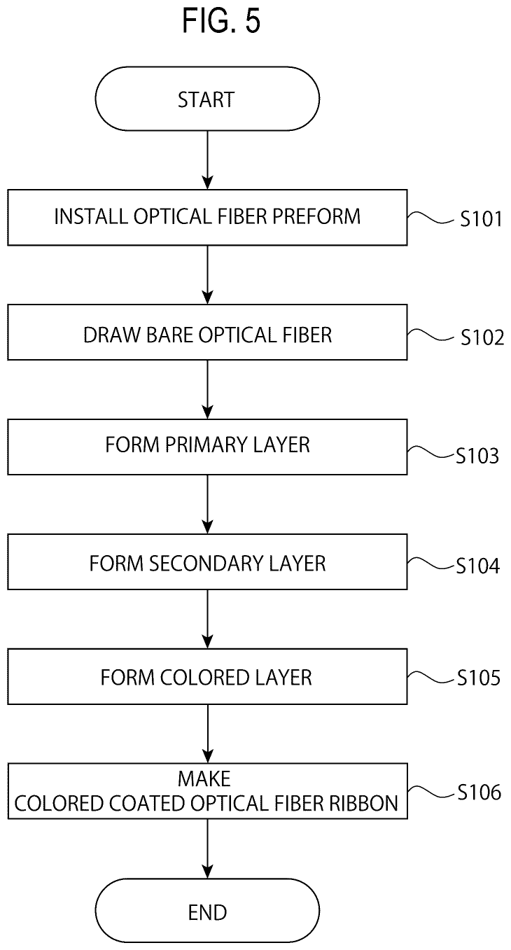

FIG. 5 is a flowchart of a manufacturing method of the colored coated optical fiber 1 and the optical fiber ribbon 100 according to the present embodiment. First, a user installs the optical fiber preform BM in the manufacturing apparatus 10 (Step S101).

Then, the heater 21 provided in the heating apparatus 20 heats the optical fiber preform BM and starts drawing the bare optical fiber 2 (Step S102).

The primary layer coating apparatus 30 applies the first ultraviolet curable resin around the drawn bare optical fiber 2 and irradiates the first ultraviolet curable resin with ultraviolet light to form the primary layer 3 (Step S103).

Next, the secondary layer coating apparatus 40 applies the second ultraviolet curable resin to the periphery of the primary layer 3 and irradiates the second ultraviolet curable resin with ultraviolet light to form the secondary layer 4 (Step S104). Thus, the coated optical fiber 6 is obtained. The coated optical fiber 6 thus manufactured is wound up in the first winding apparatus 50.

Subsequently, when the coated optical fiber 6 is pulled out from the coated optical fiber holding apparatus 55 or the first winding apparatus 50, the colored layer coating apparatus 60 applies the third ultraviolet curable resin to the periphery of the secondary layer 4 of the coated optical fiber 6, and irradiates the third ultraviolet curable resin with ultraviolet light to form the colored layer 5 (Step S105). The colored coated optical fiber 1 is obtained by coating the colored layer 5 around the coated optical fiber 6. The manufactured colored coated optical fiber 1 is wound up in the second winding apparatus 70. Note that the secondary layer 4 can be made to function as the colored layer by omitting Step S105 and coloring the secondary layer 4 in Step S104.

Note that, in the present embodiment, a plurality of colored coated optical fibers 1 having different colors of the colored layer 5 are manufactured. Therefore, the process in Step S105 is performed by changing the manufacturing conditions such as the composition of the third ultraviolet curable resin for each color.

Further, the process of forming the primary layer 3 (Step S103) does not necessarily require irradiation with ultraviolet light. In this case, the primary layer 3 may be cured in the process of forming the secondary layer 4 (Step S104).

After the colored layer 5 is formed in Step S105, the ribbon forming apparatus 80 applies the fourth ultraviolet curable resin so as to cover the plurality of colored coated optical fibers 1 prepared in different colors, irradiates the fourth ultraviolet curable resin with ultraviolet light, and connects the plurality of colored coated optical fibers 1 to each other (Step S106). Thus, the optical fiber ribbon 100 is manufactured.

In the colored coated optical fiber 1 according to the present embodiment, since the primary layer 3 is composed of the ultraviolet curable resin (first ultraviolet curable resin) containing the mercapto group-containing compound, the primary layer 3 has the mercapto group-containing compound or a structure derived from the mercapto group-containing compound. As a result of the reaction of the mercapto group-containing compound with the polymerizable compound such as urethane (meth)acrylate, the primary layer 3 has carbon-sulfur bond and specifically contains 0.03 wt % or more and 0.65 wt % or less of sulfur atoms. Note that the carbon-sulfur bond is a covalent bond between a carbon atom and a sulfur atom.

Note that the presence or absence of the carbon-sulfur bond in the primary layer 3 may be confirmed by measuring, for example, Fourier transform infrared spectroscopy (FT-IR). The content of sulfur atoms in the primary layer 3 may be measured, for example, by elemental analysis (EA).

The mercapto group-containing compound has an effect of reacting with the polymerizable compound such as urethane (meth)acrylate contained in the ultraviolet curable resin by means of a mercapto group to stop polymerization of the polymerizable compound, as described above. Therefore, the primary layer 3 has a lower saturated Young's modulus than when the primary layer 3 is composed of the ultraviolet curable resin that does not contain any mercapto group-containing compound.

That is, while the primary layer 3 has a lower Young's modulus, the increase in Young's modulus of the primary layer 3 due to the additional ultraviolet irradiation to the primary layer 3 is kept as low as 0.09 MPa or less. The primary layer 3 preferably has a Young's modulus of 0.15 MPa or more and 2.31 MPa or less. The additional UV irradiation may be performed as described below, with the ambient temperature at the time of ultraviolet irradiation set to room temperature, under any of the following conditions: an illuminance of 1000 mW/cm² and an irradiation amount of 1000 mJ/cm²; an illuminance of 1000 mW/cm² and an irradiation amount of 500 mJ/cm²; an illuminance of 500 mW/cm² and an irradiation amount of 1000 mJ/cm²; and an illuminance of 500 mW/cm² and an irradiation amount of 500 mJ/cm².

The saturated Young's modulus of the primary layer 3 composed of the ultraviolet curable resin containing the mercapto group-containing compound is preferably lowered by 10% or more with respect to the saturated Young's modulus of the primary layer composed of the ultraviolet curable resin before the addition of the mercapto group-containing compound, that is, the ultraviolet curable resin not containing the mercapto group-containing compound.

Conventionally, as described in Patent Literature 4, the negative side that the curability is lowered by using a mercapto group-containing silane coupling agent in an ultraviolet curable resin has been drawn attention. In contrast, in the present embodiment, the desired Young's modulus can be easily achieved by appropriately adding the mercapto group-containing compound to the ultraviolet curable resin. Further, in the present embodiment, since the reactive group which reacts with the radical generated from the photoinitiator by the ultraviolet irradiation does not remain in the unreacted state in the primary layer 3 even if the Young's modulus is low, the new reaction can be suppressed or prevented by the ultraviolet irradiation or the ultraviolet light exposure after manufacturing the optical fiber, and the increase in the Young's modulus of the primary layer 3 after the curing can be suppressed or prevented.

Here, there is a correlation between the amount of the mercapto group-containing compound added to the ultraviolet curable resin constituting the primary layer 3 and the amount of reduction of the saturated Young's modulus of the primary layer 3. Therefore, the Young's modulus of the primary layer 3 can be easily reduced and controlled to a desired value by controlling the amount of the mercapto group-containing compound based on the correlation between the two.

Note that, in view of sufficiently reducing the Young's modulus of the primary layer 3, the ultraviolet curable resin constituting the primary layer 3 preferably contains 0.2 wt % or more of the mercapto group-containing compound. Note that, in view of ensuring the curability of the primary layer 3, the ultraviolet curable resin constituting the primary layer 3 preferably contains 4 wt % or less of the mercapto group-containing compound. However, since the curability is determined by the number of mercapto groups to be added, it is not a problem to add 4 wt % or more depending on the molecular weight of the mercapto group-containing compound.

Because the mercapto group of the mercapto-containing compound can stop the polymerization reaction to thereby reduce the Young's modulus, the carbon-sulfur bond is not included in the repeating unit of the main chain skeleton of the primary layer 3.

Here, the glass transition temperature is one of the indexes indicating the curing state of the ultraviolet curable resin. Preferably, the glass transition temperature of the primary layer 3 does not change significantly before and after additional ultraviolet irradiation. More specifically, in the primary layer 3 by the additional ultraviolet irradiation, the change in the glass transition temperature by the additional ultraviolet irradiation is preferably within ±1.3° C. The glass transition temperature of the primary layer 3 is preferably −55° C. or more and room temperature or less. Note that room temperature means 25° C. in the present specification.

Thus, according to the present embodiment, the saturated Young's modulus can be reduced to a desired value more simply by intentionally adding the mercapto group-containing compound to the ultraviolet curable resin constituting the primary layer 3. Furthermore, according to the present embodiment, the Young's modulus of the primary layer 3 due to ultraviolet irradiation or ultraviolet light exposure after the optical fiber is manufactured can be suppressed or prevented. Thus, the Young's modulus of the primary layer 3 can be sufficiently reduced to a desired Young's modulus without a large change in the resin composition, and the increase in the Young's modulus of the primary layer 3 can be suppressed or prevented.

### EXAMPLES

Hereinafter, the results of experimentally evaluating the characteristics of the cured product of the ultraviolet curable resin used as the primary layer 3 will be described using the examples and comparative examples.

In the embodiment and the comparative example, the saturated Young's modulus is defined as the Young's modulus when the ultraviolet curable resin formed in the form of a sheet having a thickness of about 100 μm is cured by irradiating ultraviolet light so that the Young's modulus does not increase further even if ultraviolet light is additionally irradiated. The ambient temperature during ultraviolet irradiation was set to room temperature. UV light-emitting devices such as a mercury lamp, a UV-LED, and the like were used for ultraviolet irradiation. Irradiation conditions of “an illuminance of 1000 mW/cm² and an irradiation amount of 1000 mJ/cm²”, “an illuminance of 1000 mW/cm² and an irradiation amount of 500 mJ/cm²”, “an illuminance of 500 mW/cm² and an irradiation amount of 1000 mJ/cm²”, “an illuminance of 500 mW/cm² and an irradiation amount of 500 mJ/cm²”, and the like were used as main irradiation conditions. Note that the illuminance and the irradiation amount could be other conditions. For the illuminance measurement, for example, UV-351 of ORC Manufacturing Co., Ltd. was used for the mercury lamp, and for example, UVRT2/UD-T3040T2 of Topcon Technohouse Corporation was used for the UV-LED. Note that the Young's modulus was calculated by measuring the force at 2.5% elongation in an atmosphere of a temperature of 23° C. and a relative humidity of 50%, with a width of 6 mm, an interval of 25 mm between the marked lines, and a tensile speed of 1 mm/min., using a Tensilon universal tensile testing machine.

The Young's modulus of the primary layer 3 was defined as ISM (In Situ Modulus) and measured by the following method.

First, the primary layer and the secondary layer of the intermediate part of the optical fiber to be a sample were peeled off by a length of several millimeters by using a commercially available stripper, and then one end of the optical fiber on which the coating layer was formed was fixed on the slide glass with an adhesive, and a load F is applied to the other end of the optical fiber on which the coating layer was formed. In this state, the displacement d of the primary layer at the boundary between the part where the coating layer is peeled off and the part where the coating was formed was read by a microscope. Then, a graph of the displacement d with respect to the load F was created by setting the load F to 10, 20, 30, 50 and 70 gf (That is, sequentially setting to 98, 196, 294, 490, and 686 mN). Then, a primary elastic modulus was calculated using a slope obtained from the graph and the following expression (2). Since the calculated primary elastic modulus corresponds to the so-called ISM, P-ISM will be described as appropriate below. When drawing the colored coated optical fiber 1, the drawing speed and the illuminance of ultraviolet light were controlled to adjust the P-ISM.

$$P - ISM = ( 3 F / δ ) * ( 1 / 2 π l ) * ln ( DP / DG ) \qquad ( 2 )$$

The unit of P-ISM is [MPa]. F/δ is the slope indicated by the graph of the displacement (δ) [μm] with respect to the load (F) [gf], l is the sample length (e.g., 10 mm), and DP/DG is the ratio of the outer diameter (DP) [μm] of the primary layer 3 to the outer diameter (DG) [μm] of the cladding portion of the optical fiber. Therefore, when P-ISM is calculated using the above expression (2) from F, δ, and l used, a predetermined unit conversion must be performed. Note that the outer diameter of the primary layer and the outer diameter of the cladding can be measured by observing the cross section of the optical fiber cut by a fiber cutter under a microscope.

There are various possible methods for measuring the micro-bending loss. Here, the difference between the transmission loss of the optical fiber to be measured in a state A, in which the optical fiber of 400 m or more in length was wound in a single layer without overlapping each other, at a tension of 100 gf on a larger bobbin wound with a sandpaper of #1000 in number, and the transmission loss of the optical fiber in a state B, in which the optical fiber was wound on the same bobbin as the state A at the same tension and length as the state A and the bobbin was not wound with the sandpaper, was defined as the value of the micro-bending loss. Here, the transmission loss of the optical fiber in the state B did not include the micro-bending loss, and was considered to be the transmission loss inherent to the optical fiber itself.

Note that this measurement method is similar to the fixed-diameter drum method specified in JIS C6823:2010. This measurement method is also called the sandpaper method. In this measurement method, since the transmission loss was measured at a wavelength of 1550 nm, the micro-bending loss related to the present embodiment is also a value at a wavelength of 1550 nm.

In the examples and the comparative examples, various characteristics were measured on a cured product obtained by irradiating an ultraviolet curable resin formed into a sheet of about 100 μm in thickness with a mercury lamp. To the ultraviolet curable resin, 2, 4, 6-trimethylbenzoyldiphenylphosphine oxide was added as the photoinitiator. Although the mercury lamp was used as an ultraviolet light source in the present examples and the comparative examples, the ultraviolet light source is not limited to the mercury lamp but may be UV-LED of various wavelengths.

In the examples, additives A, B, and C were used the mercapto-containing compound added to and as contained in the ultraviolet curable resin. The additive A was (3-mercaptopropyl)trimethoxysilane. The additive B was isooctyl 3-mercaptopropionate. The additive C was 1-pentanethiol.

The Young's modulus after additional ultraviolet irradiation in the examples and the comparative examples was defined as the Young's modulus of the cured product when the cured product of the ultraviolet curable resin was re-irradiated with the mercury 1 amp under irradiation conditions of 500 mW/cm² and 500 mJ/cm². Note that the effect of the present invention can be confirmed by similarly applying additional ultraviolet irradiation to the colored coated optical fiber 1 of the optical fiber.

The glass transition temperature can be measured by using various analytical instruments such as differential scanning thermal analysis (DSC), thermo-mechanical analysis (TMA) and dynamic mechanical analysis (DMA). However, since the value of the glass transition temperature obtained depends on the type of measurement method, the glass transition temperature was measured using dynamic mechanical analysis in the present examples. As used herein, the glass transition temperature means that measured using dynamic mechanical analysis.

Dynamic mechanical analysis is a method of measuring by taking advantage of the fact that the molecular motion increases significantly in the glass transition region and the elastic modulus changes significantly. Namely, the Young's modulus of the resin changes significantly from about 1000 MPa to about 1 MPa, that is, by three orders of magnitude, as a result of the transition from the glass state to the rubber state, and thus the glass transition can be measured with high sensitivity.

By the way, dynamic mechanical analysis measures viscoelasticity observed when a periodically varying strain or stress is applied to an object. By performing the measurement by dynamic mechanical analysis, data on storage elastic modulus (G′), loss elastic modulus (G″), and loss tangent value (tanδ=G″/G′) can be obtained. Here, the storage elastic modulus represents the elastic element of the material, the loss elastic modulus represents the viscous element of the material, and the loss tangent represents the balance between the elastic element and the viscous element by dividing the loss elastic modulus by the storage elastic modulus. In the case of a perfect elastic body, the stress and the strain are proportional, and the stress is detected without delay for a given stress (zero phase difference). On the other hand, in the case of a perfect viscous body, since the stress and strain rate are proportional, when the stress is applied with sin(ωt), the strain of the response becomes −cos(ωt)=sin(ωt−π/2), and the strain is detected with a delay of ¼ wavelength (phase difference π/2) for the stress. The measurement detects the amount of displacement of the sample when an alternating force is applied to the sample, and the phase difference is obtained by performing a Fourier operation from the alternating force applied to the sample and the detected amount of displacement. Common polymers have a property intermediate between a fully elastic material and a viscous material, and the phase difference is between 0 and π/2. Dynamic mechanical analysis measures the relationship between the stress and the strain, and outputs a loss tangent value representing the ratio of the storage elastic modulus of the elastic component to the loss elastic modulus of the viscous component, which is a mechanical property. In the present invention, the temperature at which the loss tangent value shows a maximal value is defined the glass transition temperature. Here, the loss tangent value was measured under the following dynamic viscoelastic test conditions using RSA-G2 (registered trademark) made by TA Instruments as a dynamic viscoelastic device by cutting out a sample of a strip shape from a cured sheet of ultraviolet curable resin and fixing it to a tensile-type jig. In this measurement, the temperature at which a maximal value appeared was defined as the glass transition temperature.

### <Dynamic Viscoelastic Test Conditions>

Vibration frequency: 1 Hz
Temperature increase rate of the sample: 5° C./min.

Note that the glass transition temperature of the primary layer 3 of the optical fiber can be measured in the same manner by immersing the optical fiber in liquid nitrogen and stripping the coating with a stripper to remove the glass optical fiber from the optical fiber to use only the coating as a sample. In this case, the maximal value of the loss tangent value originating from the secondary layer 4 is also observed, but since the glass transition temperature of the secondary layer 4 and the primary layer 3 are greatly different, the maximal value of the loss tangent value originating from the primary layer 3 can be easily discriminated.

The sheet-like cured products prepared when calculating the saturated Young's modulus of the primary layer 3 before adding the additive of the mercapto group-containing compound shown in the examples and the comparative examples were cured using a mercury lamp (an illuminance of 1000 mW/cm² and an irradiation amount of 1000 mJ/cm²). The primary layer before adding the additive of the mercapto group-containing compound was the primary layer when the additive of the mercapto group-containing compound was not added.

The saturated Young's modulus of the primary layer 3 shown in the examples and the comparative examples was only one example, and generally, the Young's modulus of the primary layer 3 can be in the range of 0.1 to 3.0 MPa. The Young's modulus of the secondary layer 4 can be in the range of 500 to 2000 MPa.

The Young's modulus of the secondary layer 4 can be measured by the following measurement method. First, the optical fiber was immersed in liquid nitrogen and the coating layer was peeled off with a stripper to prepare a sample of only the coating layer in which the glass optical fiber was pulled out from the optical fiber, and an end part of the sample was fixed to an aluminum plate with an adhesive. In an atmosphere of 23° C. and 50% relative humidity, the aluminum plate part was chucked using a Tensilon universal tensile testing machine. Next, the sample was pulled with an interval of 25 mm between the marked lines and a tensile speed of 1 mm/min., and the elastic modulus (secondary elastic modulus) S-ISM (2.5% secant modulus) of the secondary layer 4 was calculated by measuring the force at the time of 2.5% stretching.

In Example 1, 0.5 wt % of the additive A was added to the ultraviolet curable resin having the saturated Young's modulus of 1.48 MPa and the glass transition temperature of −28.5° C. at the saturated Young's modulus. The saturated Young's modulus of the ultraviolet curable resin to which the additive A was added was 1.21 MPa, which was 18.2% lower than the saturated Young's modulus before the addition of the additive. The Young's modulus of the cured product cured using the mercury lamp (an illuminance of 500 mW/cm² and an irradiation amount of 500 mJ/cm²) was 1.17 MPa, and the glass transition temperature was −30.5° C. When additional UV irradiation was applied to the cured product using the mercury lamp (an illuminance of 500 mW/cm² and an irradiation amount of 500 mJ/cm²), the Young's modulus was 1.21 MPa and the amount of increase was +0.04 MPa, which was less than 0.09 MPa. The glass transition temperature was −30.1° C. and the amount of change was +0.4° C., which was within ±1.3° C.

In Example 2, 1.0 wt % of the additive A was added to the ultraviolet curable resin having the saturated Young's modulus of 1.48 MPa and the glass transition temperature of −28.5° C. at the saturated Young's modulus. The saturated Young's modulus of the ultraviolet curable resin to which the additive A was added was 1.03 MPa, which was 30.4% lower than the saturated Young's modulus before the addition of the additive. The Young's modulus of the cured product cured using the mercury lamp (an illuminance of 500 mW/cm² and an irradiation of 500 mJ/cm²) was 1.00 MPa, and the glass transition temperature was −31.0° C. When additional UV irradiation was applied to the cured product using the mercury lamp (an illuminance of 500 mW/cm² and an irradiation amount of 500 mJ/cm²), the Young's modulus was 1.03 MPa and the amount of increase was +0.03 MPa, which was less than 0.09 MPa. The glass transition temperature was −29.7° C. and the amount of change was +1.3° C., which was within ±1.3° C.

In Example 3, 2.0 wt % of the additive A was added to the ultraviolet curable resin having the saturated Young's modulus of 1.48 MPa and the glass transition temperature of −28.5° C. at the saturated Young's modulus. The saturated Young's modulus of the ultraviolet curable resin to which the additive A was added was 0.75 MPa, which was 49.3% lower than the saturated Young's modulus before the addition of the additive. The Young's modulus of the cured product cured using the mercury lamp (an illuminance of 500 mW/cm² and an irradiation amount of 500 mJ/cm²) was 0.66 MPa, and the glass transition temperature was −31.0° C. When additional UV irradiation was applied to the cured product using the mercury lamp (an illuminance of 500 mW/cm² and an irradiation amount of 500 mJ/cm²), the Young's modulus was 0.75 MPa the amount of increase was +0.09 MPa, which was less than 0.09 MPa. The glass transition temperature was −31.5° C. and the amount of change was −0.5° C., which was within ±1.3° C.

In Example 4, 3.0 wt % of the additive A was added to the ultraviolet curable resin having the saturated Young's modulus of 1.48 MPa and the glass transition temperature of −28.5° C. at the saturated Young's modulus. The saturated Young's modulus of the ultraviolet curable resin to which the additive A was added was 0.46 MPa, which was 68.9% lower than the saturated Young's modulus before the addition of the additive. The Young's modulus of the cured product cured using the mercury lamp (an illuminance of 500 mW/cm² and an irradiation amount of 500 mJ/cm²) was 0.39 MPa, and the glass transition temperature was −33.2° C. When additional UV irradiation was applied to the cured product using the mercury lamp (an illuminance of 500 mW/cm² and an irradiation amount of 500 mJ/cm²), the Young's modulus was 0.46 MPa and the amount of increase was +0.07 MPa, which was less than 0.09 MPa. The glass transition temperature was −32.0° C. and the amount of change was +1.2° C., which was within ±1.3° C.

In Example 5, 4.0 wt % of the additive A was added to the ultraviolet curable resin having the saturated Young's modulus of 1.48 MPa and the glass transition temperature of −28.5° C. at the saturated Young's modulus. The saturated Young's modulus of the ultraviolet curable resin to which the additive A was added was 0.21 MPa, which was 85.8% lower than the saturated Young's modulus before the addition of the additive. The Young's modulus of the cured product cured using the mercury lamp (an illuminance of 500 mW/cm² and an irradiation amount of 500 mJ/cm²) was 0.15 MPa, and the glass transition temperature was −33.8° C. When additional UV irradiation was applied to the cured product using the mercury lamp (an illuminance of 500 mW/cm² and an irradiation amount of 500 mJ/cm²), the Young's modulus was 0.21 MPa and the amount of increase was +0.06 MPa, which was less than 0.09 MPa. The glass transition temperature was −33.0° C. and the amount of change was +0.8° C., which was within ±1.3° C.

In Example 6, 1.0 wt % of the additive B was added to the ultraviolet curable resin having the saturated Young's modulus of 1.48 MPa and the glass transition temperature of −28.5° C. at the saturated Young's modulus. The saturated Young's modulus of the ultraviolet curable resin to which the additive B was added was 0.96 MPa, which was 35.1% lower than the saturated Young's modulus before the addition of the additive. The Young's modulus of the cured product cured using the mercury lamp (an illuminance of 500 mW/cm² and an irradiation amount of 500 mJ/cm²) was 0.95 MPa, and the glass transition temperature was −31.7° C. When additional UV irradiation was applied to the cured product using the mercury lamp (an illuminance of 500 mW/cm² and an irradiation amount of 500 mJ/cm²), the Young's modulus was 0.96 MPa and the amount of increase was +0.01 MPa, which was less than 0.09 MPa. The glass transition temperature was −30.8° C. and the amount of change was +0.9° C., which was within ±1.3° C.

In Example 7, 0.3 wt % of the additive C was added to the ultraviolet curable resin having the saturated Young's modulus of 1.48 MPa and the glass transition temperature of −28.5° C. at the saturated Young's modulus. The saturated Young's modulus of the ultraviolet curable resin to which the additive C was added was 1.32 MPa, which was 10.8% lower than the saturated Young's modulus before the addition of the additive. The Young's modulus of the cured product cured using the mercury lamp (an illuminance of 500 mW/cm² and an irradiation amount of 500 mJ/cm²) was 1.32 MPa, and the glass transition temperature was −30.0° C. When additional UV irradiation was applied to the cured product using the mercury lamp (an illuminance of 500 mW/cm² and an irradiation amount of 500 mJ/cm²), the Young's modulus was 1.32 MPa and the amount of increase was 0.00 MPa, which was less than 0.09 MPa. The glass transition temperature was −30.2° C. and the amount of change was −0.2° C., which was within ±1.3° C.

In Example 8, 0.5 wt % of the additive A was added to the ultraviolet curable resin having the saturated Young's modulus of 2.57 MPa and the glass transition temperature of −54.0° C. at the saturated Young's modulus. The saturated Young's modulus of the ultraviolet curable resin to which the additive A was added was 2.02 MPa, which was 21.4% lower than the saturated Young's modulus before the addition of the additive. The Young's modulus of the cured product cured using the mercury lamp (an illuminance of 500 mW/cm² and an irradiation amount of 500 mJ/cm²) was 2.00 MPa, and the glass transition temperature was −53.6° C. When additional UV irradiation was applied to the cured product using the mercury lamp (an illuminance of 500 mW/cm2 and an irradiation amount of 500 mJ/cm2), the Young's modulus was 2.02 MPa and the amount of increase was +0.02 MPa, which was less than 0.09 MPa. The glass transition temperature was −53.7° C. and the amount of change was −0.1° C., which was within ±1.3° C.

In Example 9, 1.0 wt % of the additive A was added to the ultraviolet curable resin having the saturated Young's modulus of 2.57 MPa and the glass transition temperature of −54.0° C. at the saturated Young's modulus. The saturated Young's modulus of the ultraviolet curable resin to which the additive A was added was 1.73 MPa, which was 32.7% lower than the saturated Young's modulus before the addition of the additive. The Young's modulus of the cured product cured using the mercury lamp (an illuminance of 500 mW/cm2 and an irradiation amount of 500 mJ/cm2) was 1.69 MPa, and the glass transition temperature was −52.8° C. When additional UV irradiation was applied to the cured product using the mercury lamp (an illuminance of 500 mW/cm2 and an irradiation amount of 500 mJ/cm2), the Young's modulus was 1.73 MPa and the amount of increase was +0.04 MPa, which was less than 0.09 MPa. The glass transition temperature was −53.0° C. and the amount of change was −0.2° C., which was within ±1.3° C.

In Example 10, 2.0 wt % of the additive A was added to the ultraviolet curable resin having the saturated Young's modulus of 2.57 MPa and the glass transition temperature of −54.0° C. at the saturated Young's modulus. The saturated Young's modulus of the ultraviolet curable resin to which the additive A was added was 1.12 MPa, which was 56.4% lower than the saturated Young's modulus before the addition of the additive. The Young's modulus of the cured product cured using the mercury lamp (an illuminance of 500 mW/cm² and an irradiation amount of 500 mJ/cm²) was 1.12 MPa, and the glass transition temperature was −52.8° C. When additional UV irradiation was applied to the cured product using the mercury lamp (an illuminance of 500 mW/cm² and an irradiation amount of 500 mJ/cm²), the Young's modulus was 1.12 MPa and the amount of increase was 0.00 MPa, which was less than 0.09 MPa. The glass transition temperature was −52.8° C. and the amount of change was 0° C., which was within ±1.3° C.

In Example 11, 3.0 wt % of the additive A was added to an ultraviolet curable resin having the saturated Young's modulus of 2.57 MPa and the glass transition temperature of −54.0° C. at the saturated Young's modulus. The saturated Young's modulus of the ultraviolet curable resin to which the additive A was added was 0.55 MPa, which was 78.6% lower than the saturated Young's modulus before the addition of the additive. The Young's modulus of the cured product cured using the mercury lamp (an illuminance of 500 mW/cm² and an irradiation amount of 500 mJ/cm²) was 0.53 MPa, and the glass transition temperature was −52.8° C. When additional UV irradiation was applied to the cured product using the mercury lamp (an illuminance of 500 mW/cm² and an irradiation amount of 500 mJ/cm²), the Young's modulus was 0.55 MPa and the amount of increase was +0.02 MPa, which was less than 0.09 MPa. The glass transition temperature was −52.8° C. and the amount of change was 0° C., which was within ±1.3° C.

In Example 12, 0.2 wt % of the additive B was added to the ultraviolet curable resin having the saturated Young's modulus of 2.57 MPa and the glass transition temperature of −54. 0° C. at the saturated Young's modulus. The saturated Young's modulus of the ultraviolet curable resin to which the additive B was added was 2.31 MPa, which was 10.1% lower than the saturated Young's modulus before the addition of the additive. The Young's modulus of the cured product cured using the mercury lamp (an illuminance of 500 mW/cm² and an irradiation amount of 500 mJ/cm²) was 2.30 MPa, and the glass transition temperature was −53.7° C. When additional UV irradiation was applied to the cured product using the mercury lamp (an illuminance of 500 mW/cm² and an irradiation amount of 500 mJ/cm²), the Young's modulus was 2.31 MPa and the amount of increase was +0.01 MPa, which was less than 0.09 MPa. The glass transition temperature was −53.9° C. and the amount of change was −0.2° C., which was within ±1.3° C.

In Example 13, 0.5 wt % of the additive B was added to the ultraviolet curable resin having the saturated Young's modulus of 2.57 MPa and the glass transition temperature of −54.0° C. at the saturated Young's modulus. The saturated Young's modulus of the ultraviolet curable resin to which the additive B was added was 2.03 MPa, which was 21.0% lower than the saturated Young's modulus before the addition of the additive. The Young's modulus of the cured product cured using the mercury lamp (an illuminance of 500 mW/cm² and an irradiation amount of 500 mJ/cm²) was 2.00 MPa, and the glass transition temperature was −53.6° C. When additional UV irradiation was applied to the cured product using the mercury lamp (an illuminance of 500 mW/cm² and an irradiation amount of 500 mJ/cm²), the Young's modulus was 2.03 MPa and the amount of increase was +0.03 MPa, which was less than 0.09 MPa. The glass transition temperature was −53.7° C. and the amount of change was −0.1° C., which was within ±1.3° C.

In Example 14, 1.0 wt % of the additive B was added to the ultraviolet curable resin having the saturated Young's modulus of 2.57 MPa and the glass transition temperature of −54.0° C. at the saturated Young's modulus. The saturated Young's modulus of the ultraviolet curable resin to which the additive B was added was 1.73 MPa, which was 32.7% lower than the saturated Young's modulus before the addition of the additive. The Young's modulus of the cured product cured using the mercury lamp (an illuminance of 500 mW/cm² and an irradiation amount of 500 mJ/cm²) was 1.73 MPa, and the glass transition temperature was −52.8° C. When additional UV irradiation was applied to the cured product using the mercury lamp (an illuminance of 500 mW/cm² and an irradiation amount of 500 mJ/cm²), the Young's modulus was 1.73 MPa and the amount of increase was 0 MPa, which was less than 0.09MPa. The glass transition temperature was −53.0° C. and the amount of change was −0.2° C., which was within ±1.3° C.

In Example 15, 2.0 wt % of the additive B was added to the ultraviolet curable resin having the saturated Young's modulus of 2.57 MPa and the glass transition temperature of −54.0° C. at the saturated Young's modulus. The saturated Young's modulus of the ultraviolet curable resin to which the additive B was added was 1.28 MPa, which was 50.2% lower than the saturated Young's modulus before the addition of the additive. The Young's modulus of the cured product cured using the mercury lamp (an illuminance of 500 mW/cm² and an irradiation amount of 500 mJ/cm²) was 1.27 MPa, and the glass transition temperature was −52.8° C. When additional UV irradiation was applied to the cured product using the mercury lamp (an illuminance of 500 mW/cm² and an irradiation amount of 500 mJ/cm²), the Young's modulus was 1.28 MPa and the amount of increase was +0.01 MPa, which was less than 0.09 MPa. The glass transition temperature was −52.8° C. and the amount of change was 0° C., which was within ±1.3° C.

In Comparative Example 1, the ultraviolet curable resin having the saturated Young's modulus of 1.48 MPa and the glass transition temperature of −28.5° C. at the saturated Young's modulus was cured with an irradiation amount of 12.5 mJ/cm² without adding any one of the additives A, B, and C. The Young's modulus of the cured product was 0.54 MPa, which was 63.5% lower than the saturated Young's modulus. The glass transition temperature was −36.9° C. When additional UV irradiation was applied to the cured product using the mercury lamp (an illuminance of 500 mW/cm² and an irradiation amount of 500 mJ/cm²), the Young's modulus was 1.48 MPa and the amount of increase was +0.94 MPa, which was more than 0.09 MPa. The glass transition temperature was −29.8° C. and the amount of change was +7.1° C., which was more than ±1.3° C.

In Comparative Example 2, the ultraviolet curable resin having the saturated Young's modulus of 2.57 MPa and the glass transition temperature of −54.0° C. at the saturated Young's modulus was cured with an irradiation amount of 12.5 mJ/cm² without adding any one of the additives A, B, and C. The Young's modulus of the cured product was 2.15 MPa, which was 16.3% lower than the saturated Young's modulus. The glass transition temperature was −55.3° C. When additional UV irradiation was applied to the cured product using the mercury lamp (an illuminance of 500 mW/cm² and an irradiation amount of 500 mJ/cm²), the Young's modulus was 2.57 MPa and the amount of increase was +0.42 MPa, which was more than 0.09 MPa. The glass transition temperature was −53.9° C. and the amount of change was +1.4° C., which was more than ±1.3° C.

The measurement results of the above examples and comparative examples are summarized in Table 1.

TABLE 1

| | Primary layer | | | | | | |
|---|---|---|---|---|---|---|---|
| | | | | | | | Decrease |
| | Saturated | | | | | Saturated | Ratio |
| | Young's | Glass transition | | | | Young's | in saturated |
| | modulus | temperature at | | | | modulus | Young's |
| | before | saturated Young's | | | | after | modulus by |
| | additive | modulus before | | Addition | Sulfur | additive | additive |
| | addition | additive addition | | amount | content | addition | addition |
| | MPa | ° C. | Additive | wt % | wt % | MPa | % |
| Example 1 | 1.48 | −28.5 | A | 0.5 | 0.08 | 1.21 | 18.2 |
| Example 2 | 1.48 | −28.5 | A | 1.0 | 0.16 | 1.03 | 30.4 |
| Example 3 | 1.48 | −28.5 | A | 2.0 | 0.33 | 0.75 | 49.3 |
| Example 4 | 1.48 | −28.5 | A | 3.0 | 0.49 | 0.46 | 68.9 |
| Example 5 | 1.48 | −28.5 | A | 4.0 | 0.65 | 0.21 | 85.8 |
| Example 6 | 1.48 | −28.5 | B | 1.0 | 0.15 | 0.96 | 35.1 |
| Example 7 | 1.48 | −28.5 | C | 0.3 | 0.09 | 1.32 | 10.8 |
| Example 8 | 2.57 | −54.0 | A | 0.5 | 0.08 | 2.02 | 21.4 |
| Example 9 | 2.57 | −54.0 | A | 1.0 | 0.16 | 1.73 | 32.7 |
| Example 10 | 2.57 | −54.0 | A | 2.0 | 0.33 | 1.12 | 56.4 |
| Example 11 | 2.57 | −54.0 | A | 3.0 | 0.49 | 0.55 | 78.6 |
| Example 12 | 2.57 | −54.0 | B | 0.2 | 0.03 | 2.31 | 10.1 |
| Example 13 | 2.57 | −54.0 | B | 0.5 | 0.07 | 2.03 | 21.0 |
| Example 14 | 2.57 | −54.0 | B | 1.0 | 0.15 | 1.73 | 32.7 |
| Example 15 | 2.57 | −54.0 | B | 2.0 | 0.29 | 1.28 | 50.2 |
| Comparative | 1.48 | −28.5 | — | — | — | 1.48 | — |
| example 1 | | | | | | | |
| Comparative | 2.57 | −54.0 | — | — | — | 2.57 | — |
| example 2 | | | | | | | |

| | Before additional | | After additional ultraviolet irradiation | | | |
|---|---|---|---|---|---|---|
| | ultraviolet irradiation | | | Increase | | Change in |
| | | Glass | | in | Glass | glass |
| | Young's | transition | Young's | Young's | transition | transition |
| | modulus | temperature | modulus | modulus | temperature | temperature |
| | MPa | ° C. | MPa | MPa | ° C. | ° C. |
| Example 1 | 1.17 | −30.5 | 1.21 | 0.04 | −30.1 | 0.4 |
| Example 2 | 1.00 | −31.0 | 1.03 | 0.03 | −29.7 | 1.3 |
| Example 3 | 0.66 | −31.0 | 0.75 | 0.09 | −31.5 | −0.5 |
| Example 4 | 0.39 | −33.2 | 0.46 | 0.07 | −32.0 | 1.2 |
| Example 5 | 0.15 | −33.8 | 0.21 | 0.06 | −33.0 | 0.8 |
| Example 6 | 0.95 | −31.7 | 0.96 | 0.01 | −30.8 | 0.9 |
| Example 7 | 1.32 | −30.0 | 1.32 | 0.00 | −30.2 | −0.2 |
| Example 8 | 2.00 | −53.6 | 2.02 | 0.02 | −53.7 | −0.1 |
| Example 9 | 1.69 | −52.8 | 1.73 | 0.04 | −53.0 | −0.2 |
| Example 10 | 1.12 | −52.8 | 1.12 | 0.00 | −52.8 | 0.0 |
| Example 11 | 0.53 | −52.8 | 0.55 | 0.02 | −52.8 | 0.0 |
| Example 12 | 2.30 | −53.7 | 2.31 | 0.01 | −53.9 | −0.2 |
| Example 13 | 2.00 | −53.6 | 2.03 | 0.03 | −53.7 | −0.1 |
| Example 14 | 1.73 | −52.8 | 1.73 | 0.00 | −53.0 | −0.2 |
| Example 15 | 1.27 | −52.8 | 1.28 | 0.01 | −52.8 | 0.0 |
| Comparative | 0.54 | −36.9 | 1.48 | 0.94 | −29.8 | 7.1 |
| example 1 | | | | | | |
| Comparative | 2.15 | −55.3 | 2.57 | 0.42 | −53.9 | 1.4 |
| example 2 | | | | | | |

In addition, 19 types of the colored coated optical fibers 1 having the Young's modulus of about 1000 MPa of the secondary layer 4 and the different Young's modulus of the primary layer 3 were randomly selected, and the Young's modulus difference and micro-bending loss difference of each primary layer 3 were calculated.

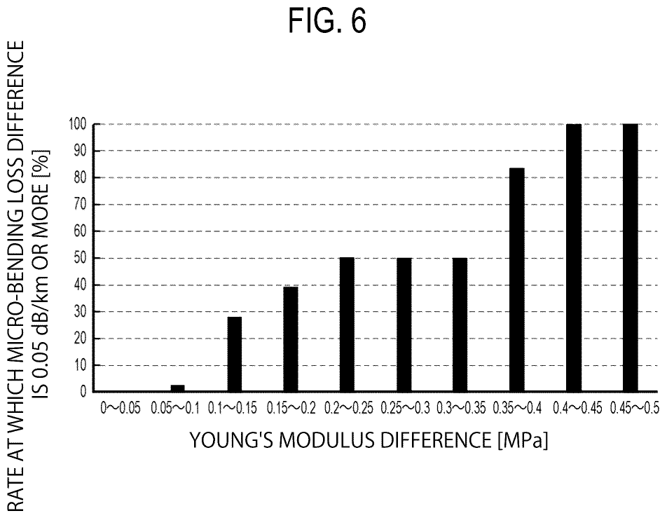

FIG. 6 is a graph diagram showing the relationship between the Young's modulus difference of the primary layer 3 and the rate at which the micro-bending loss difference is 0.05 dB/km or more by randomly selecting 19 types of the colored coated optical fibers 1 having the Young's modulus of about 1000 MPa of the secondary layer 4 and the different Young's modulus of the primary layer 3. As shown in FIG. 6, when the rate at which the micro-bending loss difference is 0.05 dB/km or more was calculated for each 0.05 MPa of Young's modulus difference of the primary layer 3, it was confirmed that the rate at which the Micro-bending loss difference is 0.05 dB/km or more rose sharply after the Young's modulus difference of the primary layer 3 was 0.1 MPa. Therefore, even when additional UV irradiation is applied to a specific coated optical fiber, it is preferable that the increase in Young's modulus of the primary layer from before the additional U irradiation to after the additional UV irradiation is 0.09 MPa or less.

What is claimed is:

1. A colored coated optical fiber comprising:
a bare optical fiber;
a primary layer formed of a first ultraviolet curable resin covering the bare optical fiber; and
a secondary layer formed of a second ultraviolet curable resin covering the primary layer,
wherein the primary layer has a carbon-sulfur bond and contains 0.03 wt % or more and 0.65 wt % or less of sulfur atoms, and
wherein an increase in a Young's modulus of the primary layer due to additional ultraviolet irradiation to the primary layer is 0.09 MPa or less.

2. The colored coated optical fiber according to claim 1, wherein the additional ultraviolet irradiation is performed under one of conditions: an illuminance of 1000 mW/cm² and an irradiation amount of 1000 mJ/cm²; an illuminance of 1000 mW/cm² and an irradiation amount of 500 mJ/cm²; an illuminance of 500 mW/cm² and an irradiation amount of 1000 mJ/cm²; and an illuminance of 500 mW/cm² and an irradiation amount of 500 mJ/cm², with an ambient temperature at a time of ultraviolet irradiation set to room temperature.

3. The colored coated optical fiber according to claim 1, wherein a change in a glass transition temperature of the primary layer by the additional ultraviolet irradiation is within ±1.3° C.

4. The colored coated optical fiber according to claim 1, wherein the primary layer contains a mercapto group-containing compound.

5. The colored coated optical fiber according to claim 1, wherein the first ultraviolet curable resin contains 0.2 wt % or more of a mercapto group-containing compound.

6. The colored coated optical fiber according to claim 1, wherein the Young's modulus of the primary layer is 0.15 MPa or more and 2.31 MPa or less.

7. The colored coated optical fiber according to claim 1, wherein a glass transition temperature of the primary layer is −55° C. or more and room temperature or less.

8. The colored coated optical fiber according to claim 1, wherein the primary layer does not include the carbon-sulfur bond in a repeating unit of a main chain skeleton of the primary layer.

9. The colored coated optical fiber according to claim 1, wherein a saturated Young's modulus of the primary layer is lowered by 10% or more with respect to a saturated Young's modulus of the primary layer composed of an ultraviolet curable resin that does not contain a mercapto group-containing compound.

10. An optical fiber ribbon including a plurality of the colored coated optical fiber according to claim 1.

11. A method of manufacturing a colored coated optical fiber, the method comprising the steps of:
drawing a bare optical fiber from an optical fiber preform;
applying a first ultraviolet curable resin around the bare optical fiber to form a primary layer; and
applying a second ultraviolet curable resin around the primary layer to form a secondary layer,
wherein the primary layer has a carbon-sulfur bond and contains 0.03 wt % or more and 0.65 wt % or less of sulfur atoms, and
wherein an increase in a Young's modulus of the primary layer due to additional ultraviolet irradiation to the primary layer is 0.09 MPa or less.

12. The method of manufacturing a colored coated optical fiber according to claim 11, the method comprising the step of applying a third ultraviolet curable resin around the coated optical fiber to form a colored layer.

13. The method of manufacturing a colored coated optical fiber according to claim 11, wherein, in the step of forming the secondary layer, the second ultraviolet curable resin that is colored is applied around the primary layer.

14. The method of manufacturing a colored coated optical fiber according to claim 11, wherein the first ultraviolet curable resin contains a mercapto group-containing compound.

15. The method of manufacturing a colored coated optical fiber according to claim 11, wherein, in the step of forming the primary layer, the first ultraviolet curable resin is irradiated with ultraviolet light.

16. The method of manufacturing a colored coated optical fiber according to claim 11, wherein, in the step of forming the secondary layer, the first ultraviolet curable resin and the second ultraviolet curable resin are irradiated with ultraviolet light.

17. A method of manufacturing an optical fiber ribbon including a plurality of the colored coated optical fiber according to claim 1.
